(19) United States
(12) Patent Application Publication
(10) Pub. No.: US 2026/0095257 A1
(43) Pub. Date: Apr. 2, 2026

(54) POWER TRANSMISSION OVER OPTICAL FIBER

(71) Applicant: Antonious Mahrous Iskander, Raleigh, NC (US)

(72) Inventor: Antonious Mahrous Iskander, Raleigh, NC (US)

(21) Appl. No.: 18/898,981

(22) Filed: Sep. 27, 2024

(51) Int. Cl. H04B 10/80; G02B 6/42; H02J 50/30; H02J 50/50; H02J 50/80

(52) U.S. Cl. CPC H04B 10/807; G02B 6/4246; H02J 50/30; H02J 50/50; H02J 50/80

(57) ABSTRACT

Transmission of electricity using fiber optics involves sending photons over the fiber optic cable where they excite electrons at a receiving end, which generate electricity when the electrons move back to a lower state.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to transmission of electricity utilizing fiber optic cables. In particular, the invention relates to sending photons over a fiber cable to generate electricity while optionally transmitting data in a receiving terminal.

### Description of Related Art

The desire to send electricity over distances without the normal dangers of wire distributed electricity has been investigated. The use of fiber optic cables is quickly becoming ubiquitous. The use of fiber optic cables has been tried with (single or multi mode) various levels of success. One such solution involves transmission of laser light over a fiber optic cable to be received by a photovoltaic receiver. Another solution uses feed light which is then split by use of a beam splitter which converts the light into various wavelengths to a plurality of photoelectric. Each of these methods has its own problems because of the multiple issues involved in the transmissions.

### BRIEF SUMMARY OF THE INVENTION

The present invention relates to a system which improves upon the prior systems to generate electricity at a distance. In this invention, a photon generator delivers photons to a first end of the fiber optic cable which then transmits the photons to a receiving terminal at the second end of the fiber optic cable. Then the received photons excite electrons in the receiving terminal and thereafter the excited electrons move back to the lower state generating electricity and simultaneously releasing the original photon which can be stored and used as electricity. This electricity can then be utilized to operate electric powered devices. Releasing the original photon at the same sequence as it was originally transmitted corresponds to the original data being unaltered.

Accordingly, in one embodiment, there is a system for generating electricity at the second end of a fiber optic cable comprising:
a) a photon generator positioned at a first end of the fiber optic cable which delivers the photons to the first end of the fiber optic cable for transmission to the second end of the fiber optic cable;
b) a receiving terminal positioned at the second end of the fiber optic cable for receiving photons sent from the first end, wherein photons excite electrons in the receiving terminal to an excited state;
c) thereafter, the excited electrons move back to an unexcited stage generating energy which is stored in an energy storage device for delivering to an electrical device; and
d) wherein the stored energy is transmitted.

In another embodiment, there is a method of generating electricity over a fiber optic cable comprising:
a) operating a photon generator which creates a stream of photons;
b) delivering the photons to a first end of the fiber optic cable for transmission to a second end of the fiber optic cable;
c) delivering the photons from the second end to a receiving terminal to excite electrons in the receiving terminal to an excited state; and
d) collecting the energy generated when the electrons in an excited state move back to a lower state.

### BRIEF DESCRIPTION OF THE DRAWINGS

FIG. 1 is a view of the system for generating electricity from a first end to a second end of a fiber optic cable.

FIG. 2 is a flow chart of the method of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one.

The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “generating electricity” refers to capturing the electrical output from an electron moving from a higher state to a lower state of energy. Energy can be stored or used directly in an electrical device. In the present invention, electrons are excited to a higher state by photon bombardment but thereafter the electron naturally returns to the unexcited state delivering energy which can be used to power an electrical device.

As used herein, the term “fiber optic cable” refers to a single mode, multi-mode, and the like, cable that contains strands of glass fibers, plastic, or other materials inside an insulated casing. They are designed for long-distance, high-performance data networking, telecommunications, and the like but certainly can be used over any distance. Compared to wired cables, fiber optic cables provide higher bandwidth and transmit data over longer distances. In the present invention they will transmit a stream of photons from a photon generator from a first end of the fiber optic cable to a second end of the fiber optic cable wherein the photons are delivered to a receiving terminal. Optional data and/or telecommunications and the like can be sent with the photons over the fiber optic cable.

As used herein, the term “photon generator” creates photons and sends them over a fiber optic element placed in a magnetic field such as that generated by an electric motor or an electric generator for generating a stream of photons. The fiber optic element is coated with a magnetically reactive material such as mercury or a mercury compound, whereby photons are released when the fiber optic element is placed in the electromagnetic field. The photons may be directed by controlling the cross section of the fiber optic element. A collector may be utilized for collecting the stream of photons. The stream of photons is delivered to a first end of a fiber optic cable for transmission to a second end, a delivery end, which allows transmission of photons over long distance. In general, there are no limitations on length.

As used herein, the term “receiving terminal” refers to a device for collecting the stream of photons from the second end of the fiber optic cable wherein the photons excite electrons in the receiving terminal to an excited state. When the excited electrons return to the unexcited state, which happens naturally after excitation, a stream of electricity is generated and stored for transmission to an electrical device used by an electrical device. The receiving terminal can be part of the fiber optic cable or external to it.

As used herein, the term “data” refers to standard data, including communication, sent over fiber optic and accompanied by the sent photons. Data can be sent in either direction on the fiber optic cable. Data can be sent separately from the photons or carried by the photons.

As used herein, the term “energy storage device” refers to a device such as a battery for storage of energy created in the receiving terminal. It also can be used immediately. It can be positioned in the receiving terminal or exterior to the receiving terminal.

As used herein, the term “repeater” refers to an electronic device that receives a signal and retransmits it. In particular, it relates to a device for taking a data stream and retransmitting the stream. It is often times necessary for data sent over long distances. Repeaters don't process information normally frequently but require a power source. In one embodiment, the system herein has one or more repeaters. In another embodiment, the electricity generated by the systems powers the repeaters.

### Drawings

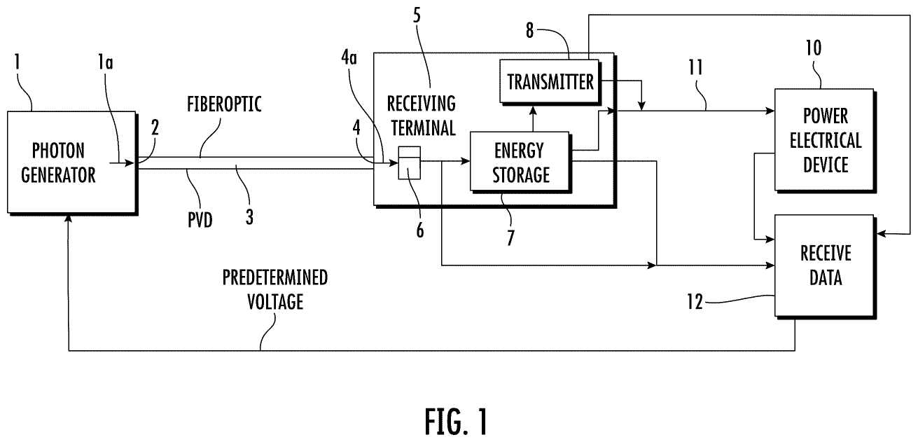

Now referring to the drawings, FIG. 1 is a view of the system for generating AC/DC electricity over any distance through fiber optic cable without the use of electrical wiring. Photon generator 1 generates photons and delivers 1a to a first end 2 of fiber optic cable 3. Photons are delivered over the fiber optic cable to a second end 4 of the fiber optic cable where photons are delivered 4a to a receiving terminal 5 containing an electron source 6. The photons excited the electrons wherein when they naturally return to an unexcited state generating electricity 6. Released energy, which can be stored in energy storage device 7, or used directly. The energy can then be transmitted 8 which delivers energy to power an electrical device 10. Data or communication can also be sent over the fiber optic cable 3 to the receiving terminal 5, or in the opposite direction, which data 11 can be sent to device 10.

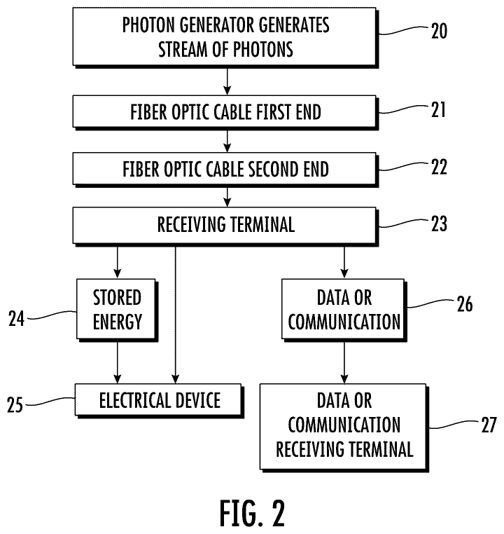

FIG. 2 is a flow chart of the method of the present invention. A photon generator generates photons 20. The photons are delivered to a first end of a fiber optic cable 21 which delivers the photons to a second end of the fiber optic cable 22. A receiving terminal 23 at the second end of the fiber optic cable receives the photons 20. The photons in the receiving terminal excite electrons in the receiving terminal to an excited state 23. The excited electrons move back to an unexcited state which generates electricity.

The energy generated in the receiving terminal is sent to a storage device 24, or directly to a device for use, which can then be sent to power electrical device 25. Energy can be sent directly to power a device. Optional data or communications 26 can be sent from the receiving terminal to the data receiving device.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A system for generating electricity at the second end of a fiber optic cable comprising:
a) a photon generator positioned at a first end of the fiber optic cable which delivers the photons to the first end of the fiber optic cable for transmission to the second end of the fiber optic cable;
b) a receiving terminal positioned at the second end of the fiber optic cable for receiving photons sent from the first end, wherein photons excite electrons in the receiving terminal to an excited state;
c) thereafter, the excited electrons move back to an unexcited stage generating energy which is stored in an energy storage device for delivering to an electrical device; and
d) wherein the stored energy is transmitted to power an electrical device.

2. The system according to claim 1 which further comprises sending data or telecommunications simultaneously with the photons through the fiber optic cable.

3. The system according to claim 1 which further comprises sending at least one of data, communications and electricity bidirectionally.

4. The system according to claim 1 wherein the receiving terminal is external to the fiber optic cable.

5. The system according to claim 1 wherein the receiving terminal is part of the fiber optic cable.

6. A system according to claim 1 which further comprises at least one repeater.

7. A system according to claim 6 wherein the repeater is powered by the electricity generated by the system.

8. A method of generating electricity over a fiber optic cable comprising:
a) operating a photon generator which creates a stream of photons;
b) delivering the photons to a first end of the fiber optic cable for transmission to a second end of the fiber optic cable;
c) the photons in the second end to excite electrons in the receiving terminal to an excited state; and
d) collecting the energy generated when the electrons in an excited state move back to an unexcited state.

9. A method according to claim 8 which further comprises one or more repeaters.

10. A method according to claim 9 wherein the repeater is powered by the generated electricity.

11. A method of generating electricity according to claim 8 which further comprises sending at least one of data, telecommunications and electricity over the fiber optic cable bidirectionally.

12. A method according to claim 8 wherein the receiving terminal is external to the fiber optic cable.

13. A method according to claim 8 wherein the receiving terminal is part of the fiber optic cable.
